(19) United States
(12) Patent Application Publication
(10) Pub. No.: US 2022/0316244 A1
(43) Pub. Date: Oct. 6, 2022

(54) MECHANICAL EMERGENCY LATCH RELEASE SYSTEM FOR VEHICLE DOOR AND METHOD

(71) Applicants: MAGNA CLOSURES INC., Newmarket (CA); MAGNA BOCO GMBH, Wuppertal (DE)

(72) Inventors: Francesco CUMBO, Pisa (IT); Konstantin KRIEGER, Leverkusen (DE)

(21) Appl. No.: 17/695,752

(22) Filed: Mar. 15, 2022

Related U.S. Application Data
(60) Provisional application No. 63/185,565, filed on May 7, 2021.
(60) Provisional application No. 63/170,775, filed on Apr. 5, 2021.

(51) Int. Cl. E05B 81/90; E05B 81/06; E05B 81/14; E05B 81/30; E05B 81/20; E05B 83/36; E05B 85/26; E05B 77/22; B60J 5/04

(52) U.S. Cl. CPC E05B 81/90; E05B 81/06; E05B 81/14; E05B 81/30; E05B 81/20; E05B 83/36; E05B 85/26; E05B 77/22; B60J 5/0413; E05B 83/243

(57) ABSTRACT

A closure panel for a motor vehicle having a power-operated latch assembly with a mechanical emergency release system and method of mechanical actuation of the power-operated latch assembly is provided. The mechanical emergency release system of power-operated latch assembly has a manually actuatable release lever and a cover for hiding the manually actuatable release lever from a user within an interior cabin of the motor vehicle. The manually actuatable release lever is accessible to the user in the interior cabin for activation after the cover has been moved.

### CROSS-REFERENCE TO RELATED APPLICATION

This application claims the benefit of U.S. Provisional Application Ser. No. 63/185,565, filed May 7, 2021, and of U.S. Provisional Application Ser. No. 63/170,775, filed Apr. 5, 2021, which are incorporated herein by way of reference in their entirety.

### FIELD

The present disclosure relates generally to power-operated closure latch assemblies of the type used in vehicle closure systems for releasably securing a closure panel relative to a body portion of a motor vehicle. More particularly, the present disclosure is directed to a power-operated closure latch assembly equipped with an emergency mechanically actuated release system.

### BACKGROUND

This section provides background information related to latch assemblies of the type used in motor vehicle closure systems and which is not necessarily prior art to the inventive concepts associated with the present disclosure.

In view of increased consumer demand for motor vehicles equipped with advanced comfort and convenience features, many modern motor vehicles are now provided with passive entry and release systems to permit locking and release of closure panels (i.e. doors, tailgates, liftgates, decklids, etc.) without the use of traditional key-type manual entry and release systems. In this regard, some of the more popular features now available with vehicular closure systems include power unlocking/locking, power release, power child locks, and power cinching. These “powered” features are typically integrated into a latch assembly mounted to the closure panel and which is equipped with a ratchet/pawl type of latch mechanism that is controlled via electric actuators. Movement of the closure panel from an open position toward a closed position results in a striker (mounted to a structural portion of the vehicle) engaging and forcibly rotating the ratchet, in opposition to biasing normally applied to the ratchet via a ratchet biasing member, from a striker release position toward a striker capture position. Once the ratchet is located in its striker capture position, the pawl moves into a ratchet holding position whereat the pawl engages and holds the ratchet in its striker capture position, thereby latching the latch mechanism and holding the closure panel in its closed position. In most modern latch assemblies of the type equipped with such a ratchet/pawl latch mechanism, the pawl is operable in its ratchet holding position to retain the ratchet in both of a primary (i.e. “hard close”) striker capture position when the closure panel is located in a fully-closed position and a secondary (i.e. “soft close”) striker capture position when the closure panel is located in a partially-closed position.

Latch assemblies providing a power release feature typically include a latch release mechanism actuated by an electric “power release” actuator to cause the pawl to move from its ratchet holding position to a ratchet releasing position whereat the pawl is disengaged from the ratchet. Thereafter, the ratchet biasing member moves the ratchet from one of its primary and secondary striker capture positions into its striker release position, thereby releasing the latch mechanism and permitting movement of the vehicle closure panel to its open position. The power release actuator is controlled by a latch control unit in response to a latch release signal generated by the passive entry system (i.e. via a key fob or a switch, such as a handle-mounted switch).

Latch assemblies providing a power cinching feature typically include a latch cinch mechanism actuated by an electric “power cinch” actuator and configured to cause the ratchet to move from its secondary striker capture position into its primary striker capture position, thereby moving the closure panel from its partially-closed position into its fully-closed position. The latch cinch mechanism is normally maintained in a non-actuated condition and is only shifted into an actuated condition when sensors associated with the latch mechanism indicate that the ratchet is located in its secondary striker capture position. Upon being actuated, the latch cinch mechanism moves the closure panel from its partially-closed position into its fully-closed position in uninterrupted fashion. Following completion of the power cinching operation, when the sensors indicate that the ratchet is located in its primary striker capture position, the latch cinch mechanism is reset. Specifically, the latch cinch mechanism is returned to its non-actuated condition via powered actuation so as to permit uninhibited movement of the ratchet to its striker release position in response to subsequent powered actuation of the latch release mechanism. If the closure panel is initially closed with sufficient closing force to locate the ratchet in its primary striker capture position, then the powered cinching operation is bypassed and the latch cinch mechanism is maintained in its non-actuated condition.

Although the electric power latch release and power cinching mechanisms are desired, should an issue arise with the source of electric power to the latch release/cinch mechanism, the closure panel may not be able to be opened until the issue with the source of electric power is resolved. Accordingly, would be desirable to have an ability to override the electric power latch release and power cinching mechanisms to be able to open the closure panel in the event an issue arises with the source of electric power to the latch release/cinch mechanism.

While current power-operated latch assemblies and cinching features thereof are sufficient to meet all regulatory requirements and provide desired levels of enhanced comfort and convenience, a need continues to exist directed toward advancing the technology and providing alternative power-operated closure latch assemblies and sub-systems thereof that address and overcome at least some of the known shortcomings associated with conventional power-operated closure latch arrangements, such as discussed above.

### SUMMARY

This section provides a general summary of some of the inventive concepts associated with the present disclosure. Accordingly, this section is not intended to be interpreted as a comprehensive and exhaustive listing of all features, aspects, objectives and/or advantages associated with the inventive concepts of the present disclosure that are further described and illustrated in the detailed description provided herein.

It is an objective of the present disclosure to provide a power-operated closure latch assembly that meets the above-identified needs and provides a technological advancement over known power-operated closure latch assemblies by providing an ability to open a closure panel via a manual actuation mechanism in the event an issue arises with a source of electric power to the power-operated closure latch assembly.

It is another objective of the present disclosure to prevent inadvertent or unwanted actuation of the manual actuation mechanism of the power-operated closure latch assembly, such as during a crash event.

It is still a further objective of the present disclosure to provide the manual actuation mechanism of the power-operated closure latch assembly in an economical, easy to use manner.

It is still a further objective of the present disclosure to prevent unintended access to the manual actuation mechanism of the power-operated closure latch assembly to prevent inadvertent manual actuation to the latch assembly.

It is still a further objective of the present disclosure to prevent unwanted access to the manual actuation mechanism of the power-operated closure latch assembly to provide a theft preventative/deterrent.

It is still a further objective of the present disclosure to require intent to access to the manual actuation mechanism of the power-operated closure latch assembly easy, while providing a simple mechanism for allowing intended access thereto.

In accordance with these and other objectives, the present disclosure is directed to a closure panel for a motor vehicle, wherein the closure panel is configured for movement from a fully closed position, whereat the closure panel closes off an opening into an interior of the motor vehicle, to an open position, whereat the closure panel allows ingress through the opening into the interior and egress through the opening from the interior. The closure panel comprises a latch assembly having a latch mechanism with a ratchet moveable between a striker release position, whereat the ratchet is positioned to release a striker to permit the closure panel to move to the open position, and a primary striker capture position, whereat the closure panel is held in the fully closed position. The latch mechanism further includes a pawl moveable between a ratchet holding position, whereat the pawl is positioned to hold the ratchet in its primary striker capture position, and a ratchet releasing position, whereat the pawl is positioned to permit movement of the ratchet to its striker release position. The latch mechanism further includes a latch release mechanism configured for powered actuation of the latch mechanism to move the pawl between the ratchet holding position and the ratchet releasing position. Further yet, the latch release mechanism includes a manually actuatable release lever moveable between a non-actuated position, whereat the manually actuatable release lever permits the pawl to be located in its ratchet holding position, and an actuated position, whereat the manually actuatable release lever causes the pawl to move to its ratchet releasing position. The closure panel includes a cover configured for movement between a covered position, whereat access to the manually actuatable release lever is prevented, and an uncovered position, whereat access to the manually actuatable release lever is permitted. While the cover is in the covered position, manual actuation of the manually actuatable release lever by a user is prevented, and while the cover is in the uncovered position, manual actuation of the manually actuatable release lever by the user is permitted. Accordingly, manual actuation of the latch mechanism via the manually actuatable release lever requires the cover be moved to the uncovered position.

In accordance with another aspect, the cover can be provided having a blocking feature configured to prevent movement of the manually actuatable release lever from the non-actuated position to the actuated position. As such, inadvertent movement of the manually actuatable release lever from the non-actuated position to the actuated position is prevented while the cover is in the covered position.

In accordance with another aspect, the blocking feature can be configured to engage the manually actuatable release lever when the cover is in the covered position, thereby functioning as a physical stop to prevent movement of the manually actuatable release lever from the non-actuated position to the actuated position.

In accordance with another aspect, the cover can be configured for attachment directly to a metal panel underlying a decorative inner panel of the closure panel, wherein the decorative inner panel is configured to allow access to the cover when desired. As such, although the cover is accessible when desired, the cover can be concealed beneath the decorative inner panel.

In accordance with another aspect, the cover can be configured for attachment directly to a decorative inner panel of the closure panel. As such, the cover, when desired, can be quickly identified and moved from the covered position to the uncovered position for quick and easy manual actuation of the manually actuatable release lever.

In accordance with another aspect, the cover can be located such that it is accessible to be moved from the covered position to the uncovered position from the interior of the motor vehicle by a vehicle occupant while the closure panel is in the fully closed position. As such, the vehicle occupant can ready open the closure panel without assistance from a person outside the motor vehicle.

In accordance with another aspect, the manually actuatable release lever is only moveable from the non-actuated position to the actuated position when the cover is in the uncovered position. As such, intentional movement of the manually actuatable release lever from the non-actuated position to the actuated position is assured.

In accordance with another aspect, the closure panel can be provided having at least one of an outside closure panel handle and an inside closure panel handle, wherein the at least one outside closure panel handle and inside closure panel handle is configured in electrical communication with the latch release mechanism. Accordingly, the at least one outside closure panel handle and inside closure panel handle is configured signal powered actuation of the latch release mechanism.

In accordance with another aspect, the at least one outside closure panel handle and inside closure panel handle can be configured so as to not in mechanically coupled communication with the latch release mechanism. Accordingly, the latch mechanism is not mechanically actuatable via the at least one outside closure panel handle and inside closure panel handle.

In accordance with another aspect, the latch mechanism can include a powered-operated cinch mechanism moveable between a rest position, whereat the cinch mechanism is disengaged from the ratchet, and an engaged position, whereat the cinch mechanism engages the ratchet to move the ratchet from a secondary striker capture position to its primary striker capture position. The manually actuatable release lever can be configured to over-ride the powered-operated cinch mechanism upon being moved from the non-actuated position to the actuated position. As such, regardless of the position of the powered-operated cinch mechanism, the closure panel can be opened via mechanical actuation of the manually actuatable release lever.

In accordance with another aspect of the disclosure, a door for a motor vehicle includes a latch assembly having a manually actuatable release lever and a cover concealing the manually actuatable release lever from a user within an interior cabin of the motor vehicle while the cover is in a covered position. The manually actuatable release lever is made accessible for selective activation by the user within the interior cabin after the cover has been moved from the covered position to an uncovered position.

In accordance with another aspect of the disclosure, the cover of the door has a blocking feature configured to prevent movement of the manually actuatable release lever from the non-actuated position to the actuated position while in the covered position.

In accordance with another aspect of the disclosure, the manually actuatable release lever of the door is only moveable from the non-actuated position to the actuated position when the blocking feature is moved out from engagement with the manually actuatable release lever, which occurs only upon the cover being moved to the uncovered position.

In accordance with another aspect of the disclosure, the door can only be moved from the closed position to an open position via powered actuation of an electric motor while the cover is concealing the manually actuatable release lever.

In accordance with another aspect of the disclosure, the door has at least one of an outside closure panel handle and an inside closure panel handle, the at least one outside closure panel handle and inside closure panel handle being configured in electrical communication with a latch release mechanism.

In accordance with another aspect of the disclosure, the at least one outside closure panel handle and inside closure panel handle of the door are not in mechanically coupled communication with the latch release mechanism.

In accordance with another aspect, a door for a motor vehicle in accordance with an aspect of the disclosure includes a latch assembly configured for actuation to move from a latched state, whereat the door is in a closed position, to an unlatched state, whereat the door can be moved from the closed position to an open position, solely via powered actuation of an electric motor. The door includes a manually actuatable release lever moveable from a non-actuated position to an actuated position, whereat the door can be moved from the closed position to the open position. A cover is configured for movement between a covered position, whereat access to the manually actuatable release lever is prevented, and an uncovered position, whereat access to the manually actuatable release lever is permitted. While the cover is in the covered position, manual actuation of the manually actuatable release lever by a user is prevented, and while the cover is in the uncovered position, manual actuation of the manually actuatable release lever by the user is permitted.

In accordance with another aspect, a method of permitting a power-actuated latch mechanism of a closure panel of a motor vehicle to be mechanically unlatched to allow the closure panel moved from a closed position to an open position is provided. The method includes providing the closure panel having a cover that is moveable from a covered position to an uncovered position to allow access to a manually actuatable release lever of the power-actuated latch mechanism. Further, configuring the manually actuatable release lever for movement from a non-actuated position to an actuated position, whereat the power-actuated latch mechanism moves under mechanically driven bias from a latched state to an unlatched state, whereat the door can be moved from the closed position to the open position.

In accordance with another aspect, the method can include locating the cover on the closure panel to allow a user in an interior cabin of the motor vehicle to have access to the cover while the closure panel is in the closed position.

In accordance with another aspect, the method can include configuring the cover to prevent the manually actuatable release lever from moving from the non-actuated position to the actuated position while the cover is in the covered position.

In accordance with another aspect, the method can include configuring the manually actuatable release lever to over-ride a powered-operated cinch mechanism upon being moved from the non-actuated position to the actuated position.

It is a further objective of the present disclosure to provide a pedestrian protection feature for use in conjunction with a front hood latching system of a motor vehicle which addresses at least those issues discussed above.

It is a related objective of the present disclosure to further provide a pedestrian protection feature a motor vehicle hood latch and closure system for use with front trunk (frunk) hood.

It is a further objective of the present disclosure to provide a motor vehicle hood latch and a pedestrian protection system having an ability to automatically sense an imminent front end impact and release a vehicle hood from a fully closed position to a partially open, pop-up position without need of action from a driver of the vehicle and prior to a pedestrian impacting the vehicle hood.

In accordance with these and other objectives, it is an aspect of the present disclosure to provide an active hinge assembly providing a pedestrian protection feature that embodies the inventive concepts set forth in the following detailed description and illustrations.

It is a further aspect of the present disclosure to provide a method of configuring an active hinge assembly with a pedestrian protection feature that embodies the inventive concepts set forth in the following detailed description and illustrations.

In accordance with another aspect of the disclosure, an active hinge assembly for a hood of a motor vehicle is provided. The active hinge assembly includes a body bracket configured for fixed attachment to a body of the motor vehicle; a deploy bracket operably coupled to the body bracket to provide pivotal movement of a first end of the hood between a fully closed position and a fully open position; a hood bracket operably coupled to the deploy bracket for movement between a non-deployed position and a deployed position to provide pivotal movement of a second end of the hood, opposite the first end, from a rest position to a raised pop-up position; and a spring lock member having a resilient spring finger configured for engagement with a stop feature of the hood bracket, the stop feature being configured to deflect the resilient spring finger from a non-deflected position to a deflected position during movement of the hood bracket from the non-deployed position toward the deployed position, as the hood bracket reaches the deployed position, the resilient spring finger snaps resiliently from the deflected position to the non-deflected position into blocking obstruction with the stop feature to prevent the hood bracket from moving from the deployed position toward the non-deployed position, thereby maintaining the hood in the pop-up position.

In accordance with another aspect, the active hinge assembly can further include the deploy bracket is pivotably coupled to the body bracket at a first pivot location.

In accordance with another aspect, the active hinge assembly can further include a plurality of links pivotably connect the deploy bracket to the body bracket.

In accordance with another aspect, the active hinge assembly can further include the hood bracket is pivotably attached to the deploy bracket at a second pivot location.

In accordance with another aspect, the active hinge assembly can further include the second pivot location is between the first pivot location and the first end of the hood.

In accordance with another aspect, the active hinge assembly can further include the spring lock member has a main body fixed to the deploy bracket.

In accordance with another aspect, the active hinge assembly can further include the resilient spring finger has a deflection surface configured for sliding engagement with the stop feature as the hood bracket s moving from the non-deployed position to the deployed position to facilitate moving the resilient spring finger from the non-deflected position to the deflected position.

In accordance with another aspect, the active hinge assembly can further include the resilient spring finger extends from the main body in cantilevered fashion to a stop surface at a free end of the resilient spring finger.

In accordance with another aspect, the active hinge assembly can further include the stop surface is aligned axially beneath a lock surface of the end stop for engagement with the lock surface when the hood bracket moves from the deployed position toward the non-deployed position.

In accordance with another aspect of the disclosure, a method of automatically moving a hood of a motor vehicle from a fully closed position to a partially open, pop-up position in advance of impacting a pedestrian and maintaining the hood in the partially open, pop-up position to minimize the potential for injury to the pedestrian upon the pedestrian impacting the hood is provided.

In accordance with another aspect of the disclosure, a method of causing a hood of a motor vehicle to move from a closed position to a partially open, pop-up position, and for maintaining the hood in the partially open, pop-up position, in advance of impacting a pedestrian to minimize the potential for injury to the pedestrian upon impacting the hood is provided. The method includes a step of providing a powered actuator; a step of configuring a hood bracket to move from a non-deployed position toward a deployed position in response to actuation of the powered actuator; a step of configuring a spring lock member to move from a non-deflected position to a deflected position in response to the hood bracket moving from the non-deployed position toward the deployed position with the actuator; a step of configuring the hood to move from the closed position to the partially open, pop-up position in response to the hood bracket moving from the non-deployed position to the deployed position; and a step of configuring the spring lock member to move from the deflected position to the non-deflected position in response to the hood bracket reaching the deployed position and preventing movement of the hood bracket from the deployed positon toward the non-deployed position with the spring lock member to maintain the hood in the pop-up position.

In accordance with another aspect, the method can further include a step of configuring a body bracket for fixed attachment to the motor vehicle and fixing a deploy bracket for pivotal movement relative to the body bracket and configuring a first end of the hood to move from a fully closed position to an open position in response the deploy bracket pivoting relative to the body bracket.

In accordance with another aspect, the method can further include a step of locating the hood bracket adjacent a second end of the hood opposite the first end and causing the second end to move to the pop-up position in response to movement of the hood bracket from the non-deployed position to the deployed position.

In accordance with another aspect, the method can further include a step of configuring the first end of the hood to remain latched with a closure latch assembly when the second end is moved to the pop-up position.

In accordance with another aspect, the method can further include a step of providing the spring lock member having a resilient spring finger and configuring the resilient spring finger to deflect from the non-deflected position to the deflected position under a biasing force imparted by a stop feature of the hood bracket engaging the resilient spring finger during movement of the hood bracket from the non-deployed position toward the deployed position and configuring the resilient spring finger to move from the deflected position to the non-deflected position in response to the stop feature moving out from engagement with the resilient spring finger upon the hood bracket reaching the deployed position and configuring a free end of the resilient spring finger to confront the stop feature to prevent movement of the hood bracket from the deployed positon toward the non-deployed position to maintain the hood in the pop-up position.

In accordance with another aspect of the disclosure, there is provided an active hinge assembly for a hood of a motor vehicle, including a body bracket configured for fixed attachment to a body of the motor vehicle, a hood bracket operably coupled to the body bracket for movement between a non-deployed position and an active pedestrian protection pop-up position, and a pawl configured for engagement with a stop feature of the hood bracket, the pawl having a blocking position and an unblocking position, wherein the pawl is configured to be move to the blocking position when the hood bracket is moved to the active pedestrian protection pop-up position and engage with the stop feature to prevent the hood bracket returning to the non-deployed position after moving to the active pedestrian protection pop-up position. The pawl can be biased towards the blocking position. The pawl can be a resilient spring. The hood bracket can include a deploy bracket and the pawl is positioned on the deploy bracket. The pawl can be moveable from the blocking position to an unblocking position when the hood bracket is moved from the non-deployed position and an active pedestrian protection pop-up position. The pawl can be moveable from the unblocking position to the non-deployed position when the hood bracket is moved to the active pedestrian protection pop-up position. The pawl can prevent the hood from returning to the non-deployed position from the active pedestrian protection pop-up position when the pawl is in the blocking position.

Further areas of applicability will become apparent from the detailed description provided herein. The description and specific examples disclosed in this summary are provided for purposes of illustration only and do not act to limit the scope of the present disclosure.

### BRIEF DESCRIPTION OF THE DRAWINGS

The drawings described herein are provided to illustrate selected, non-limiting embodiments associated with the present disclosure and are not intended to limit the scope of the present disclosure.

FIG. 1 is a partial perspective view of a motor vehicle having a closure panel equipped with a closure latch assembly and release system constructed in accordance with the teachings of the present disclosure;

FIGS. 1A-1C illustrate alternate locations of an access opening on an inside portion of the closure panel of FIG. 1 in accordance with alternate embodiments of the disclosure;

FIG. 2 is an isometric view of a portion of a latch mechanism associated with the closure latch assembly and release system shown in FIG. 1;

FIG. 3 is a partial side view of a portion of the latch mechanism shown in FIG. 2;

FIG. 4A is a plan view illustrating the a portion of the latch mechanism in a released state or position;

FIG. 4B is a similar plan view to FIG. 4A illustrating the latch mechanism in an initial or secondary closed state or position;

FIG. 4C is a similar plan view to FIG. 4A illustrating the latch mechanism in a final or primary closed state or position;

FIG. 4D is an isometric view of the latch mechanism in its primary closed state or position;

FIGS. 5A and 5B illustrate an alternative version of a roller-type pawl of a latch mechanism operating in its primary closed state;

FIG. 6 is a plan view of a latch assembly in accordance with an embodiment of the disclosure with a mount plate removed for clarity purposes only;

FIG. 6A is an isometric view of the latch assembly of FIG. 6 with the mount plate installed;

FIG. 7 is an isometric view of the latch assembly of FIGS. 6 and 6A illustrating a numeric sequence of movements 1-10 of latch mechanism components during a manual actuation;

FIG. 8A is a schematic side view of a closure panel illustrating a cover releasably attached thereto in accordance with one aspect of the disclosure with a blocking feature of the cover shown in operable communication with a component of the latch mechanism;

FIG. 8B is a view similar to FIG. 8A illustrating a cover releasably attached to a closure panel in operable communication with a component of the latch mechanism in accordance with another aspect of the disclosure;

FIG. 9 is a schematic plan view of a user manually actuating a latch mechanism of a closure panel to move the latch mechanism from a locked state to a released state to allow the closure panel to be moved from a closed position to an open position;

FIG. 10 is a flow diagram illustrating method of manually actuating a latch mechanism of a closure panel from a locked state to a released state in accordance with an aspect of the disclosure to allow the closure panel to be moved from a closed position to an open position;

FIGS. 11A-11C illustrate a progressive sequence of a front hood of a motor vehicle being actuated to move from a fully closed position (FIG. 11A) to a pop-up position (FIGS. 11B and 11C) via automatic actuation of an active hinge assembly providing a pedestrian protection feature constructed according to one aspect of the present disclosure;

FIG. 12 illustrates a side partial view of the vehicle of FIG. 11 illustrating the active hinge assembly of the front hood constructed according to one aspect of the present disclosure, wherein the active hinge assembly is shown in a non-deployed, rest home position;

FIG. 13A illustrates a schematic side view of the front hood being latched at one end by a latch assembly and being support for pivotal movement at an opposite end by an active hinge assembly in accordance with an aspect of the disclosure;

FIG. 13B is a view similar to FIG. 13A showing the latch assembly in an unlatched state and the vehicle hood pivoted in a normal use condition via the active hinge assembly to a fully open position;

FIG. 13C is a view similar to FIG. 13A showing the latch assembly in a latched state and the vehicle hood moved in a pedestrian protection condition via the active hinge assembly to a pop-up position;

FIG. 14 is a side view of the active hinge assembly with a hood bracket thereof shown in a non-deployed position;

FIG. 15 is a view similar to FIG. 14 showing the hood bracket in a deployed position;

FIGS. 16A-16E are schematic side views illustrating a progression of an actuator being deployed to move the hood bracket of the active hinge assembly from the non-deployed position, corresponding to FIG. 14, to the deployed position, corresponding to FIG. 15;

FIG. 17 is a flow diagram illustrating a method of automatically moving a hood of a motor vehicle from a fully closed position to a partially open, pop-up position in advance of impacting a pedestrian; and

FIG. 18 is a flow diagram illustrating a method of causing a hood of a motor vehicle to move from a closed position to a partially open, pop-up position, and for maintaining the hood in the partially open, pop-up position, in advance of impacting a pedestrian to minimize the potential for injury to the pedestrian upon impacting the hood.

Corresponding reference numbers are used to indicate corresponding components throughout the several views of the drawings.

### DETAILED DESCRIPTION OF EXAMPLE EMBODIMENTS

Example embodiments of a closure latch assembly and mechanically actuatable auxiliary/emergency latch release system therefor will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

In the following detailed description, the expression “latch assembly” will be used to generally, as an illustrative example, indicate any power-operated latch device adapted for use with a vehicle closure panel to provide a power cinch feature in combination with a power and mechanical auxiliary/emergency release feature. Additionally, the expression “closure panel” will be used to indicate any element moveable between an open position and at least one closed position, respectively opening and closing an access to an inner compartment of a motor vehicle and therefore includes, without limitation, decklids, tailgates, liftgates, bonnet lids, and sunroofs in addition to the sliding or pivoting side passenger doors of a motor vehicle to which the following description will make explicit reference, purely by way of example.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

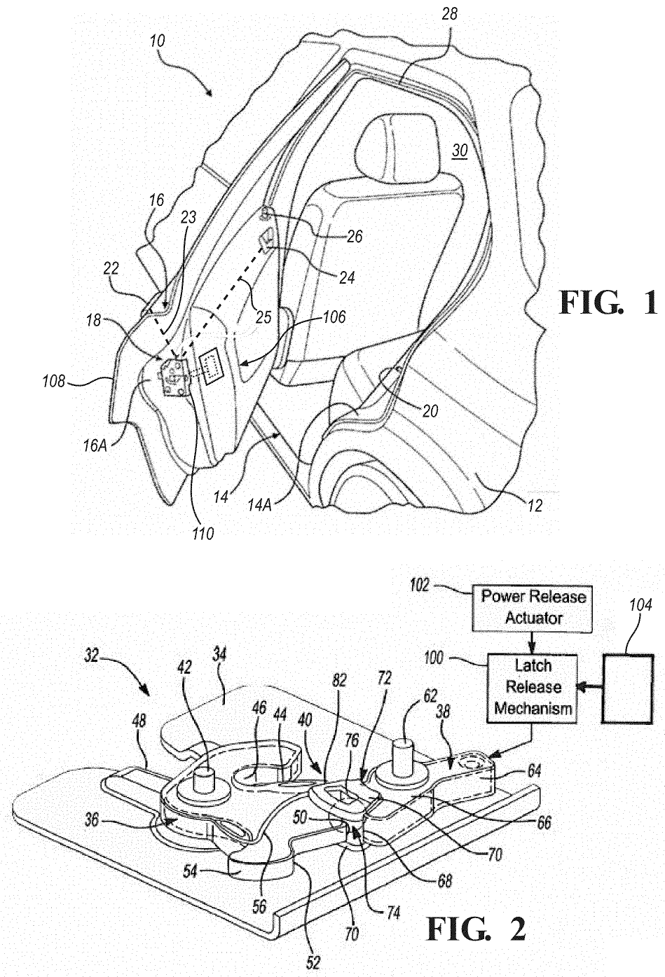

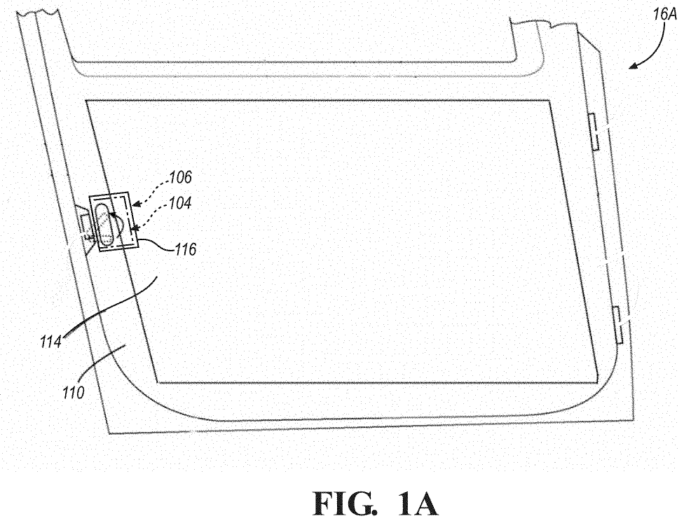

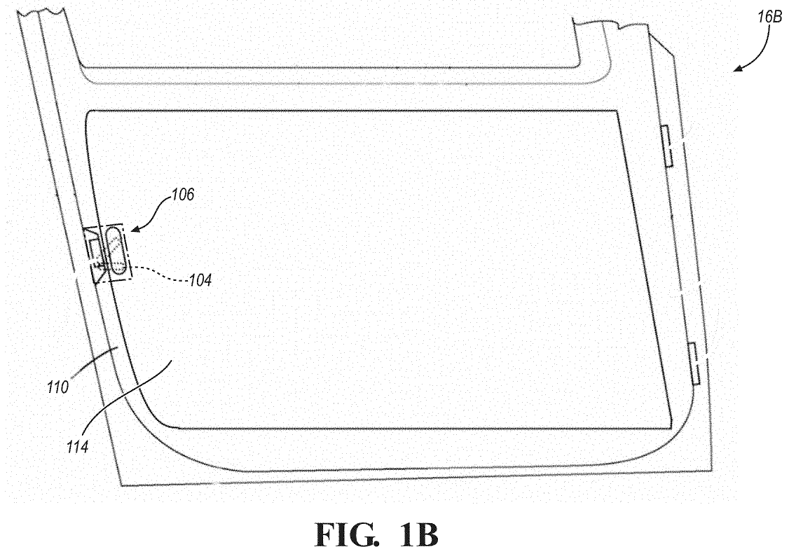

Referring initially to FIG. 1 of the drawings, a motor vehicle 10 is shown to include a vehicle body 12 defining an opening 14 to an interior passenger compartment. A closure panel 16 is pivotably mounted to body 12 for movement between an open position (shown), a partially-closed position, and a fully-closed position relative to opening 14. A latch assembly 18 is rigidly secured to closure panel 16 adjacent to an edge portion 16A thereof and is releasably engageable with a striker 20 that is fixedly secured to a recessed edge portion 14A of opening 14. As will be detailed, latch assembly 18 housing a latch mechanism 32 is operable to engage striker 20 and releasably hold closure panel 16 in one of its partially-closed and fully-closed positions. An outside handle 22 and an inside handle 24 are provided for actuating (i.e. mechanically and/or electrically) latch assembly 18 to release striker 20 and permit subsequent movement of closure panel 16 to its open position. An optional lock knob 26 is shown which provides a visual indication of the locked state of latch assembly 18 and which may also be operable to mechanically change the locked state of latch assembly 18. A weather seal 28 is mounted on edge portion 14A of opening 14 in vehicle body 12 and is adapted to be resiliently compressed upon engagement with a mating sealing surface on closure panel 16 when closure panel 16 is held by latch assembly 18 in its fully-closed position so as to provide a sealed interface therebetween which is configured to prevent entry of rain and dirt into the passenger compartment while minimizing audible wind noise. For purpose of clarity and functional association with motor vehicle 10, the closure panel is hereinafter referred to as door 16.

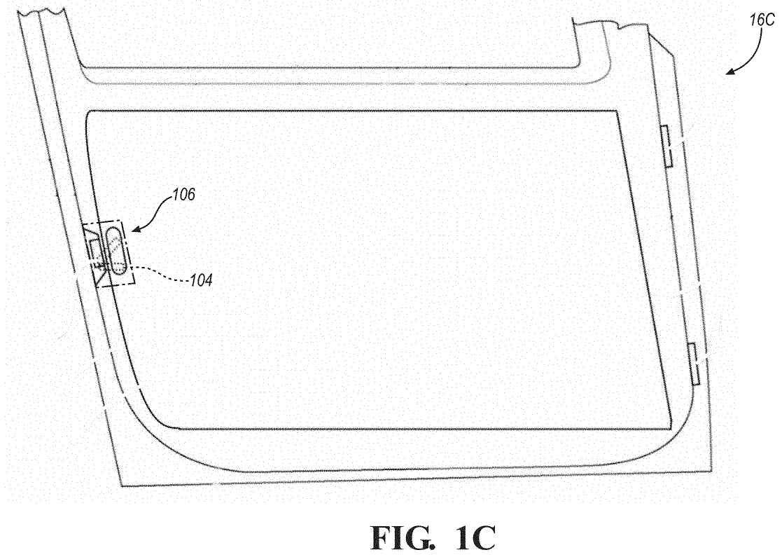

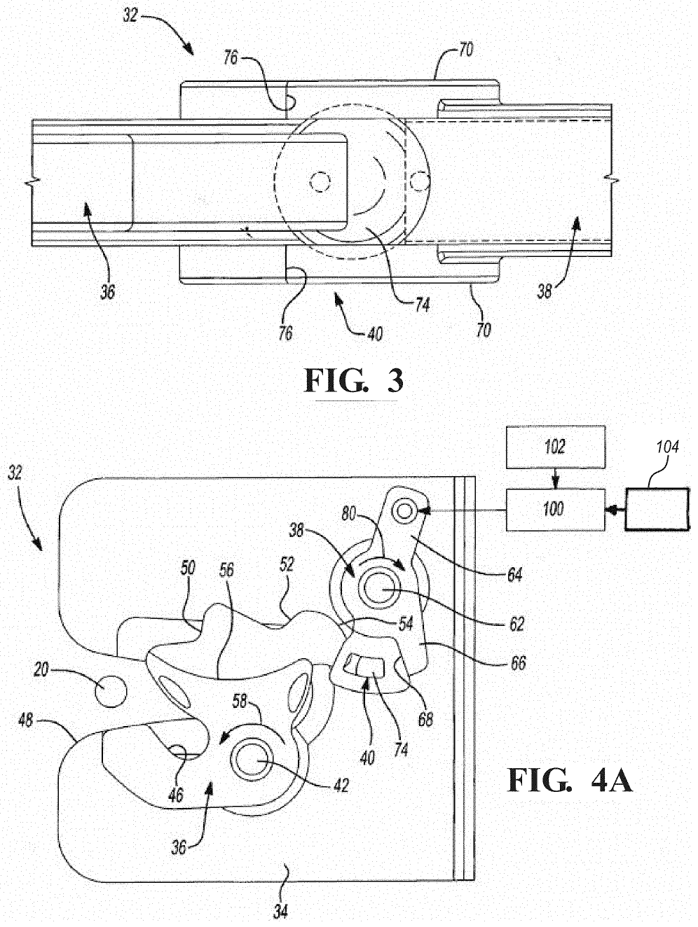

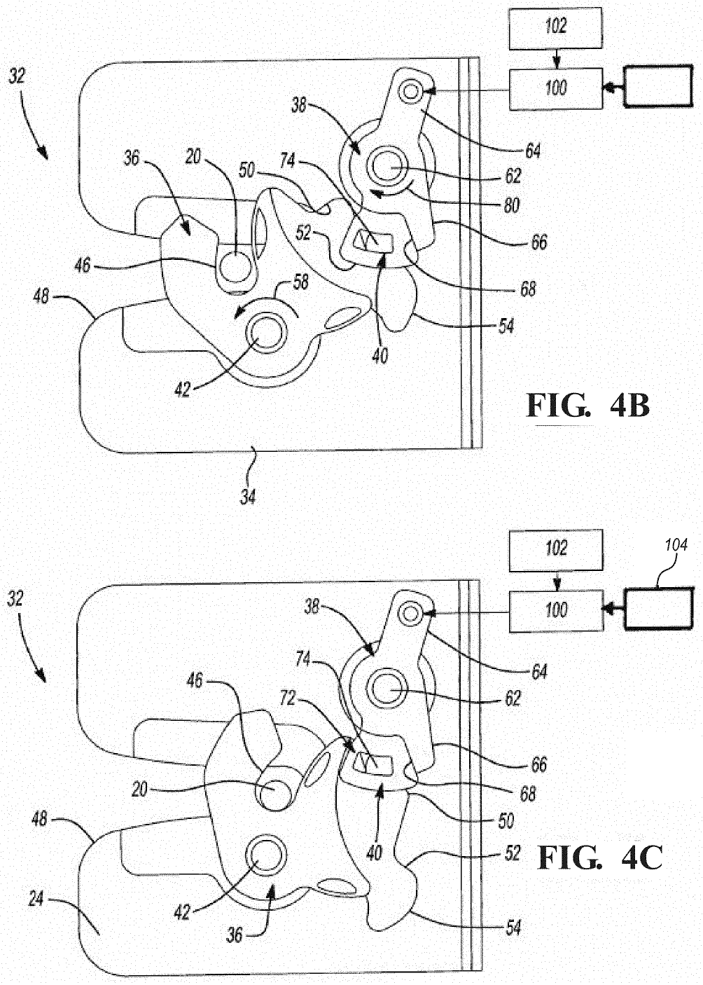

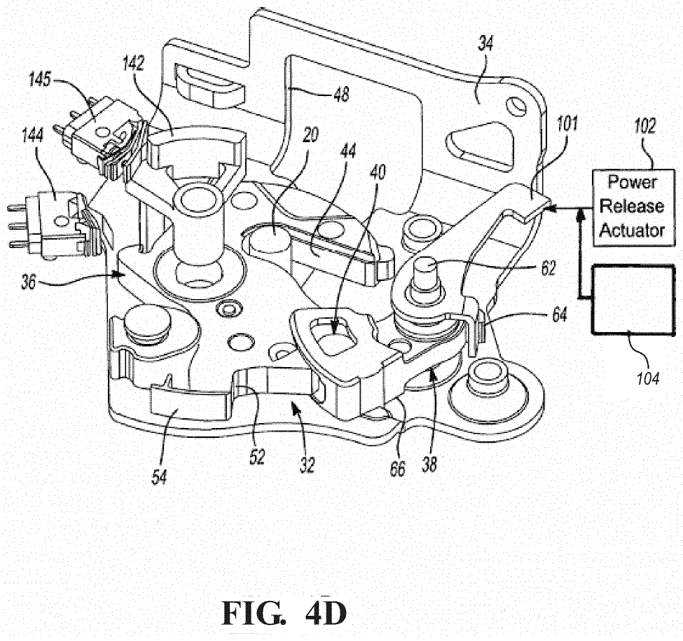

Referring now primarily to FIGS. 2, 3 and 4, various components of a latch mechanism 32 are shown pivotably mounted to a latch frame plate 34 and generally include a ratchet 36, a pawl 38, and a roller-type engagement device 40. Ratchet 36 is supported by a ratchet pivot post 42 for movement between a striker release position (FIG. 4A), a soft close or secondary striker capture position (FIG. 4B), and a hard close or primary striker capture position (FIGS. 4C and 4D). Ratchet 36 includes a striker guide channel 44 terminating in a striker retention cavity 46. As seen, latch frame plate 34 includes a fishmouth slot 48 aligned to accept movement of striker 20 relative thereto. Ratchet 36 includes a primary latch notch 50, a secondary latch notch 52, and an edge surface 54. A raised guide surface 56 is also formed on ratchet 36. Arrow 58 indicates a ratchet biasing member that is arranged to normally bias ratchet 36 toward its striker release position.

Pawl 38 is shown pivotably mounted to latch frame plate 34 about a pawl pivot post 62 and includes a first pawl leg segment 64 and a second pawl leg segment 66 defining a pawl engagement surface 68. Roller-type engagement device 40 is secured to second pawl leg segment 66 of pawl 38 and includes a pair of oppositely-disposed sidewalls 70 defining a cage 72, and a roller, shown as a spherical ball bearing 74, that is retained by cage 72 within aligned roller slots 76 formed in sidewalls 70. Pawl 38 is pivotable between a ratchet releasing position (FIG. 4A) and a ratchet holding position (FIGS. 4B, 4C and 4D). Pawl 38 is normally biased toward its ratchet holding position by a pawl biasing member, indicated by arrow 80.

As shown in FIG. 4A, pawl 38 is held in its ratchet releasing position when ratchet 36 is located in its striker release position due to engagement of ball 74 with pawl engagement surface 68 and with edge surface 54 on ratchet 36, whereby a released operating state for latch mechanism 32 is established. As shown in FIG. 4B, ball 74 engages pawl engagement surface 68 on pawl 38 and secondary latch notch 52 on ratchet 36 so as to cause pawl 38, when located in its ratchet holding position, to hold ratchet 36 in its secondary striker capture position. In this orientation, striker 20 is retained between ratchet guide channel 46 and fishmouth slot 48 in latch plate 34 to hold door 16 in a partially-closed position and establish a secondary closed state for latch mechanism 32. Finally, FIGS. 4C and 4D illustrate pawl 38 located in its ratchet holding position with ball 74 engaging pawl engagement surface 68 on pawl 38 and primary latch notch 50 on ratchet 36 such that pawl 38 holds ratchet 36 in its primary striker capture position so as to hold door 16 in its fully-closed position and establish a primary closed operating state for latch mechanism 32.

A latch release mechanism 100 is shown schematically to be connected to first pawl leg segment 64 of pawl 36. Latch release mechanism 100 may include a release lever 101 (FIG. 4D) that is moveable between non-actuated and actuated positions to cause corresponding movement of pawl 38 between its ratchet holding and ratchet releasing positions. In addition, a power release actuator 102 is shown schematically connected to release lever 101 of latch release mechanism 100. Actuation of power release actuator 102 causes release lever 101 to move pawl 38 from its ratchet holding position into its ratchet releasing position. Power release actuator 102 is preferably an electric motor-driven arrangement. A ratchet switch lever 142 is mounted to ratchet 36 and works in cooperation with a ratchet release sensor 144 to provide a “door open” signal when ratchet 36 is located in its striker release position and a secondary latched sensor 145 to provide a “door ajar” signal when ratchet 36 is located in its secondary striker capture position. As is well known, these signals are used by a latch controller unit (ECU) to control operation of power release actuator 102.

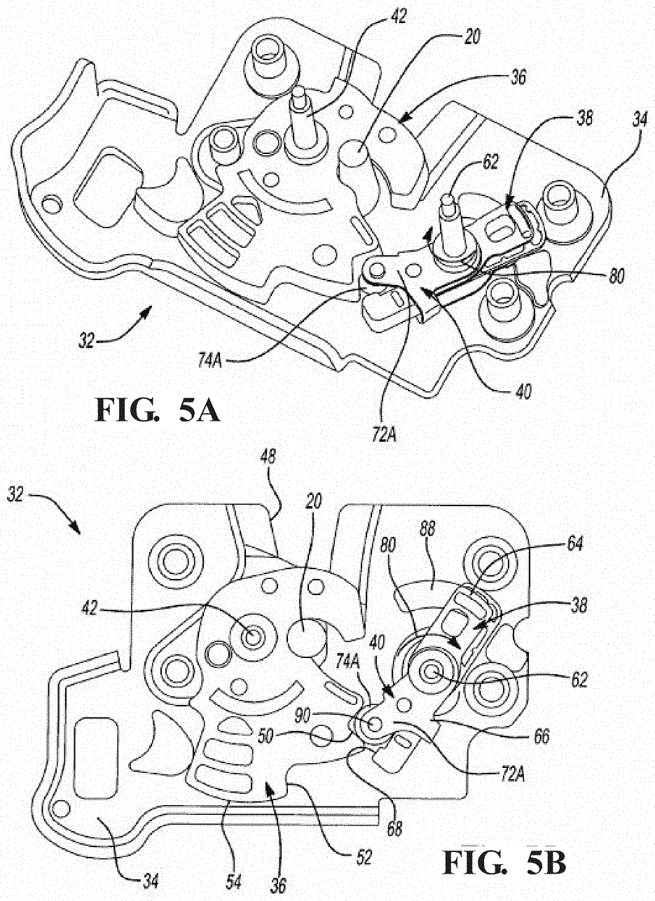

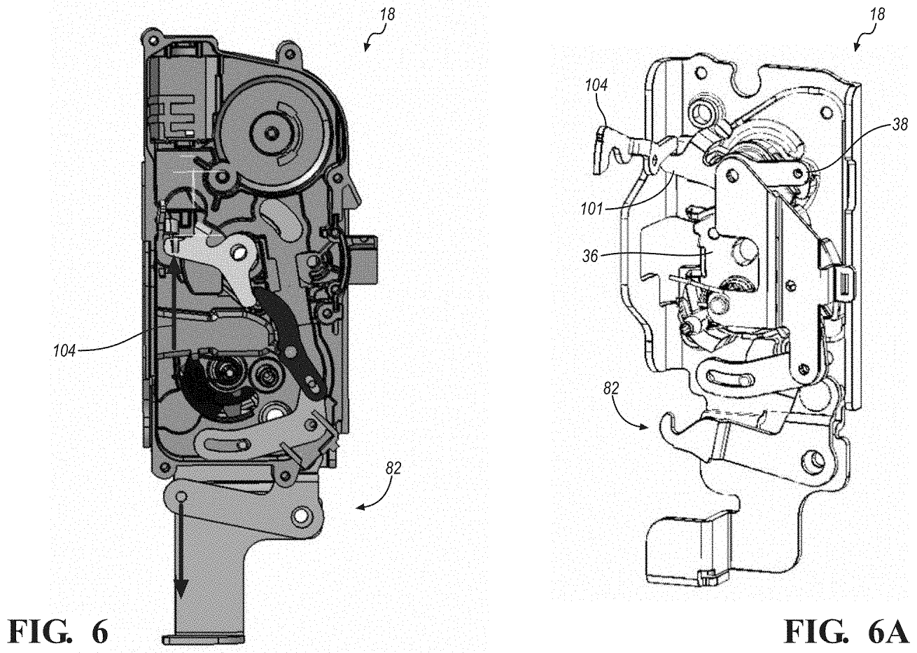

FIGS. 5A and 5B are provided to more clearly illustrate the engagement of a roller 74A associated with engagement device 40 between pawl surface 68 on pawl 38 and primary latch notch 50 on ratchet 36 when ratchet 36 is held in its primary striker capture position by pawl 38 being positioned in its ratchet holding position. A lug 86 on first pawl leg segment 64 of pawl 38 is shown positioned within an arcuate guide slot 88 formed in latch plate 34 to provide guided pivotal movement of pawl 38. Lug 86 may engage an actuation mechanism, such as power release actuator 102 provided on an opposite side of latch plate 34 in accordance with an illustrative embodiment.

It will be understood by a person possessing ordinary skill the art of closure panel latches that the above latch assembly 18 and latch mechanism 32 thereof are configured for powered actuation via one or more electric motors, including a power-operated cinch actuator, with outside and inside door handles 22, 24 being configured in electrical communication with latch assembly 18 solely via respective electrical wires 23, 25, with no mechanical actuation mechanism in the form of mechanical linkage extending from the outside and inside door handles 22, 24 to the latch assembly 18. Accordingly, under normal use, movement of closure panel 16 from the fully-closed position to the open position requires selective powered actuation of power release actuator 102 to move latch mechanism 32 between its latched and unlatched states, thereby requiring electrical power to be supplied to power release actuator 102.

In accordance with an aspect of the disclosure, in the event electrical power is interrupted to power release actuator 102 for any reason, a user (vehicle occupant) in an interior cabin 30 of motor vehicle 10 is able to mechanically actuate latch assembly 18 by gaining access to a mechanical emergency release system 103 including a manually (via a vehicle occupant hand actuation, for example, as shown in FIG. 9) actuatable release lever 104 to move manually actuatable release lever 104 between a non-actuated position, whereat the manually actuatable release lever 104 permits the pawl to 38 be located in its ratchet holding position, and an actuated position, whereat the manually actuatable release lever 104 causes the pawl 38 to move to its ratchet releasing position to move latch mechanism 32 from the latched state to the unlatched state and the power-operated cinch mechanism 82 to be over-ridden, thereby allowing the door 16 to be moved from the closed position to the open position.

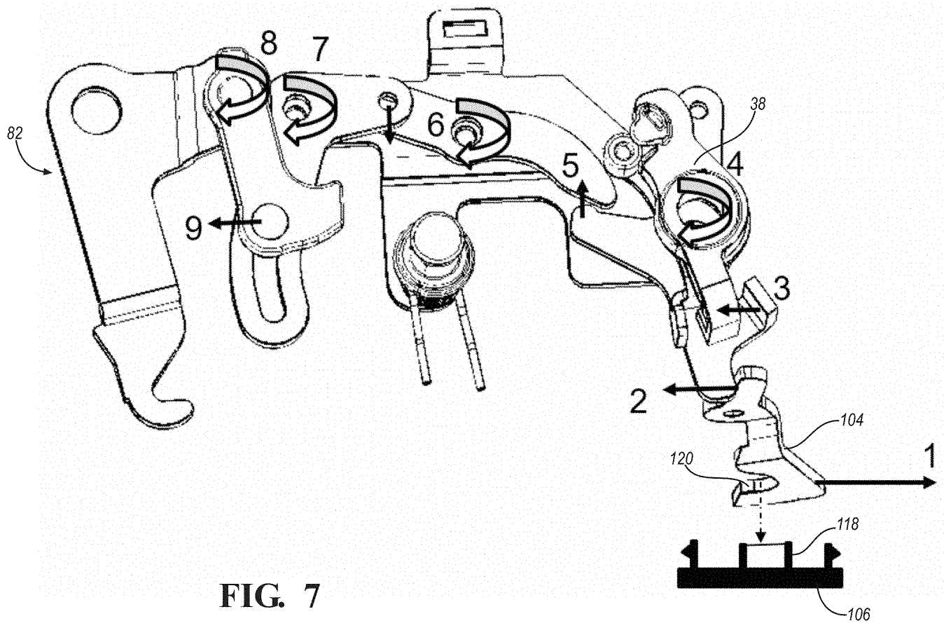

The closure panel 16 includes a cover 106 configured for movement between a covered position, whereat access to the manually actuatable release lever 104 is prevented, and an uncovered position, whereat access to the manually actuatable release lever 104 is permitted, whereat movement of manually actuatable release lever 104 establishes a chain reaction of lever movements 1-10, as identified in FIG. 7. While the cover 106 is in the covered position, manual actuation of the manually actuatable release lever 104 by a user is prevented, and while the cover 106 is in the uncovered position, manual actuation of the manually actuatable release lever 104 by the user is permitted. Accordingly, manual actuation of the latch mechanism 32 via the manually actuatable release lever 104 requires the cover 106 be moved to the uncovered position.

The cover 106 can be located such that it is accessible to be moved from the covered position to the uncovered position from the interior cabin 30 of the motor vehicle 10 by a vehicle occupant while the closure panel 16 is in the fully closed position. As such, the vehicle occupant can ready open the closure panel 16 without assistance from a person outside the motor vehicle 10 in event powered-operation of latch assembly 18 is unavailable.

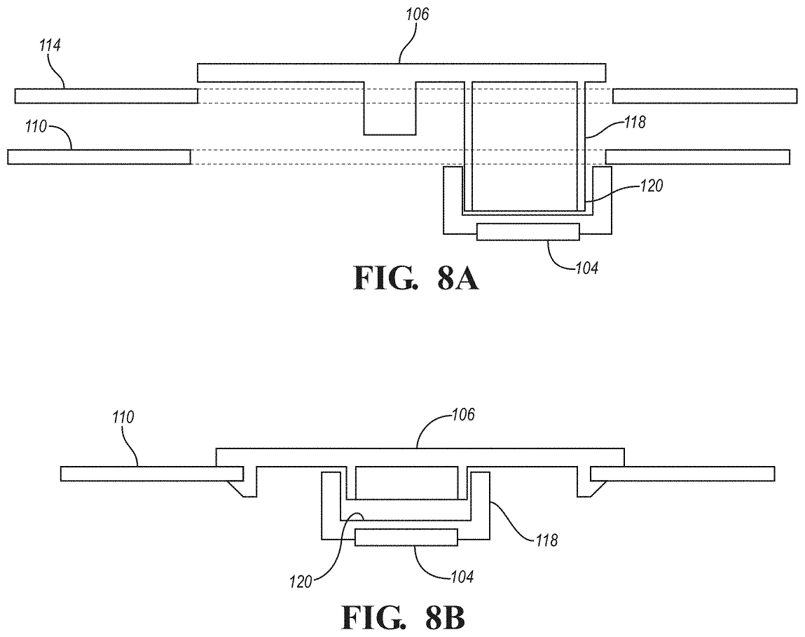

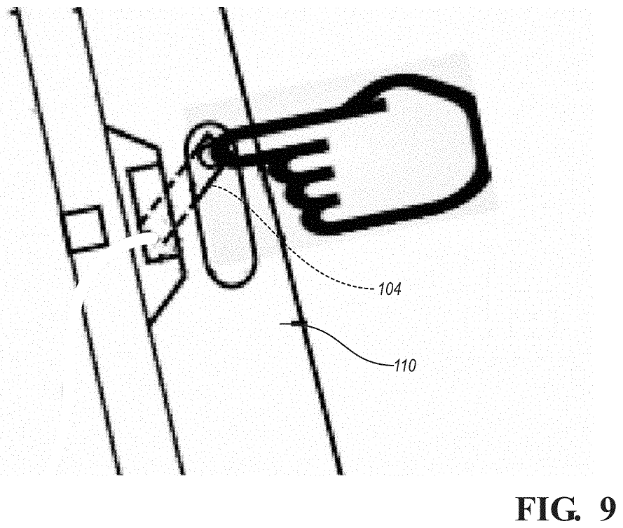

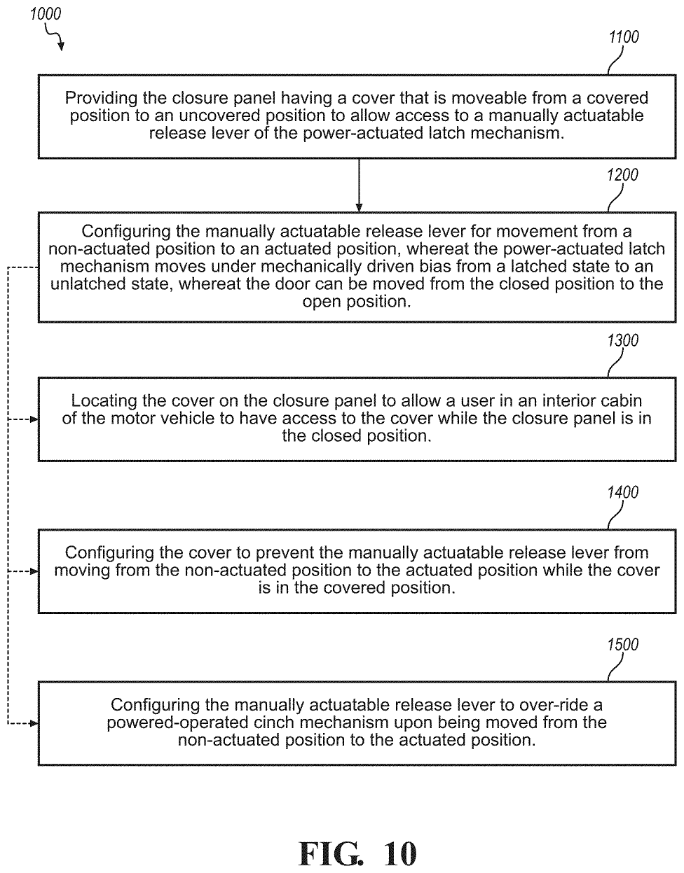

The closure panel 16 has an outer metal panel 108 (FIG. 1) fixed to an inner metal panel 110 to define an inner cavity therebetween, wherein various components of latch assembly 18, window guide rails (not shown) and other component associated with a window 112 can be disposed, wherein the various components can be supported by a carrier (not shown) disposed in the inner cavity, as is known. The cover 106 can be configured for attachment directly to a metal panel, such as the inner metal panel 110 (FIG. 1A illustrating closure panel 16A, 1B illustrating closure panel 16B and 8B), wherein cover 106 can underlie a decorative inner panel 114 of the closure panel 16A (FIGS. 1A and 8B). If cover 106 underlies the decorative inner panel 114, the decorative inner panel is 114 configured to allow access to the cover 106 when desired. As such, although the cover 106 is accessible when desired, such as via folding an access flap 116 of the decorative inner panel 114 back, the cover 106 can remain concealed beneath the access flap 116 of the decorative inner panel 114, such that the cover 106 is not viewable by a vehicle occupant while in the interior cabin 30 during normal use. Otherwise, as shown in FIG. 1B, cover 106 can be located in plain sight off to a side of decorative inner panel 114, thereby being readily identifiable when desired to remove the cover 106 to the uncovered position for access to manually actuatable release lever 104.

In accordance with another aspect, the cover 106 can be configured for attachment directly to the decorative inner panel 114 (FIG. 1C illustrating closure panel 16C and 8B) of the closure panel 16C. As such, the cover 106, when desired, can be quickly identified, as being located in plain sight, and moved from the covered position to the uncovered position for quick and easy manual actuation of the manually actuatable release lever 104. Manually actuatable release lever 104 is illustratively shown as mounted to the latch frame plate 34, but in another possible configuration manually actuatable release lever 104 or another manual lever coupled to the manually actuatable release lever 104 (such as for example via a bowden cable) may be mounted remotely from the latch frame plate 34 such as on a door module or a door carrier, or to another support structure mounted to the door 16, to an inner trim panel, or mounted directly to door 16, as but illustrative examples.

The cover 106 can be provided having a blocking feature 118 configured to prevent movement of the manually actuatable release lever 104 from the non-actuated position to the actuated position. As such, inadvertent movement of the manually actuatable release lever 104 from the non-actuated position to the actuated position is prevented while the cover 106 is in the covered position. The blocking feature 118 can be configured to engage the manually actuatable release lever 104 when the cover 106 is in the covered position, thereby functioning as a physical stop to prevent movement of the manually actuatable release lever 104 from the non-actuated position to the actuated position. The blocking feature 118 can be configured having any desired shape to act as a physical stop, and is shown, by way of example and without limitation, as being generally cylindrical for receipt with a similarly shaped recess or pocket 120 of manually actuatable release lever 104. As such, the manually actuatable release lever 104 is only moveable from the non-actuated position to the actuated position when the blocking feature 118 is moved out of engagement from the manually actuatable release lever 104 upon the cover 106 being moved to the uncovered position. As such, intentional movement of the manually actuatable release lever 104 from the non-actuated position to the actuated position requires moving the cover 106 from the covered position to the uncovered position.

In accordance with another aspect, a method 1000 of permitting a power-actuated latch mechanism 100 of a closure panel 16 of a motor vehicle 10 to be mechanically unlatched to allow the closure panel 16 to be moved from a closed position to an open position is provided. The method 1000 includes a step 1100 of providing the closure panel 16 having a cover 106 that is moveable from a covered position to an uncovered position to allow access to a manually actuatable release lever 104 of the power-actuated latch mechanism 100. Further, a step 1200 of configuring the manually actuatable release lever 104 for movement from a non-actuated position to an actuated position, whereat the power-actuated latch mechanism 100 moves under mechanically driven bias from a latched state to an unlatched state, whereat the closure panel 16 can be moved from the closed position to the open position.

In accordance with another aspect, the method 1000 can include a step 1300 of locating the cover 106 on the closure panel 16 to allow a user in an interior cabin 30 of the motor vehicle 10 to have access to the cover 106 while the closure panel 16 is in the closed position.

In accordance with another aspect, the method 1000 can include a step 1400 of configuring the cover 106 to prevent the manually actuatable release lever 104 from moving from the non-actuated position to the actuated position while the cover 106 is in the covered position.

In accordance with another aspect, the method 1000 can include a step 1500 of configuring the manually actuatable release lever 104 to over-ride a power-operated cinch mechanism 82 upon being moved from the non-actuated position to the actuated position.

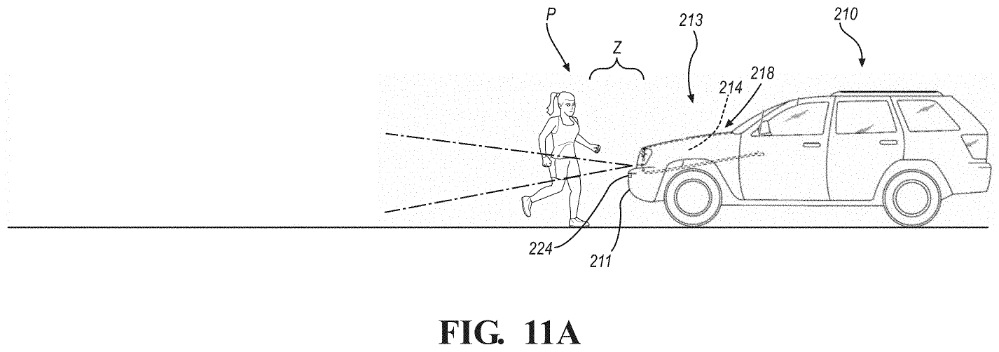

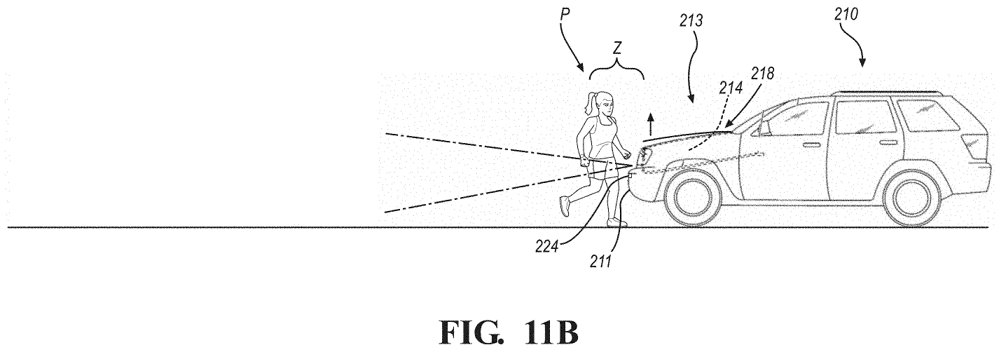

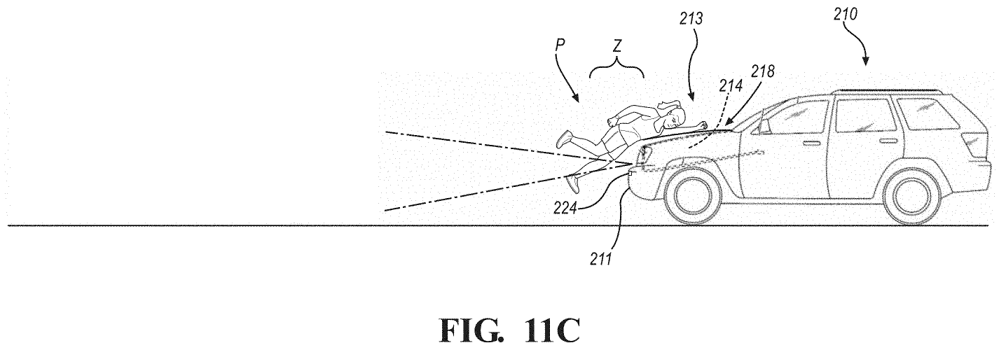

In accordance with another aspect, FIGS. 11A-11C illustrates a motor vehicle 210 having a body 211 defining a front compartment 214, which in some embodiments may be an engine compartment and in other embodiments may be a storage compartment, otherwise known as a front trunk, sometimes referred to as “frunk.” In this non-limiting example of motor vehicle 210, a closure panel assembly 213 includes a closure panel, configured as a front hood, also referred to simply as hood 212, is pivotably mounted to body 211 for movement relative to the front compartment between a fully-closed position FIG. 11A, and a partially-open or pop-up position FIGS. 11B and 11C. Illustratively, the closure panel 212 is a hood provided at the front of the motor vehicle 210 for enclosing an engine bay or a frunk, also referred to as stowage compartment. Hood 212 may be manually released from within a passenger compartment of vehicle 210 and which functions to actuate a latch release mechanism associated with a closure latch assembly 216 of the closure panel assembly 213 for releasing hood 212 and permitting subsequent pivotal movement of hood 212 via an active hinge assembly 218 of the closure panel assembly 213 constructed in accordance with the disclosure to its fully-open position. Closure latch assembly 216 is, in this non-limiting embodiment, secured to a structural portion of vehicle body 211 adjacent to the front compartment and is configured to releasably engage a striker 222 mounted in fixed relation to an underside of hood 212. Striker 222 is shown as being fixed to a leading edge or end, also referred to as first end 220 of hood 212, while active hinge assembly 218 is shown as being fixed to a trailing edge or end, also referred to as second end 221 of hood 212, by way of example and without limitation. It is contemplated herein that the striker 222 could be fixed to the second end 221 of hood, with active hinge assembly 218 being fixed to the first end 220 of hood 212, if desired, with active hinge assembly 218 still be able to move hood 212 to the pop-up position to provide pedestrian protection functionality.

Closure latch assembly, referred to hereafter as latch 216 includes at least one ratchet 223 and at least one pawl 225. The ratchet 223 is movable between a primary closed position, also referred to as primary striker capture position, a secondary closed position, also referred to as secondary striker capture position, and an open position, also referred to as striker release position, in response to selective movement of the pawl 225 between ratchet holding and ratchet releasing positions, wherein ratchet 223 is biased toward the striker release position be a ratchet biasing member (not shown). In the primary and secondary closed positions, the ratchet 223 prevents the withdrawal of the striker 222 from the ratchet 223. When in the primary closed position, the ratchet 212 holds the striker 222 relatively deeper within a slot, commonly referred to fishmouth of a latch housing, wherein the hood 212 is in a fully closed state, as compared to when ratchet 223 is in the secondary closed position, wherein the hood 212 is in a partially closed state, but prevented from being moved to the fully open position by ratchet 223. Thus, in the primary closed position the ratchet 223 holds the striker 222 at a first depth in the fishmouth whereat the hood 212 is in a fully closed position, and in the secondary closed position the ratchet 223 holds the striker 222 at a second depth in the fishmouth of the housing whereat the hood 212 is in the partially closed, pop-up position, wherein the first depth is greater than the second depth.

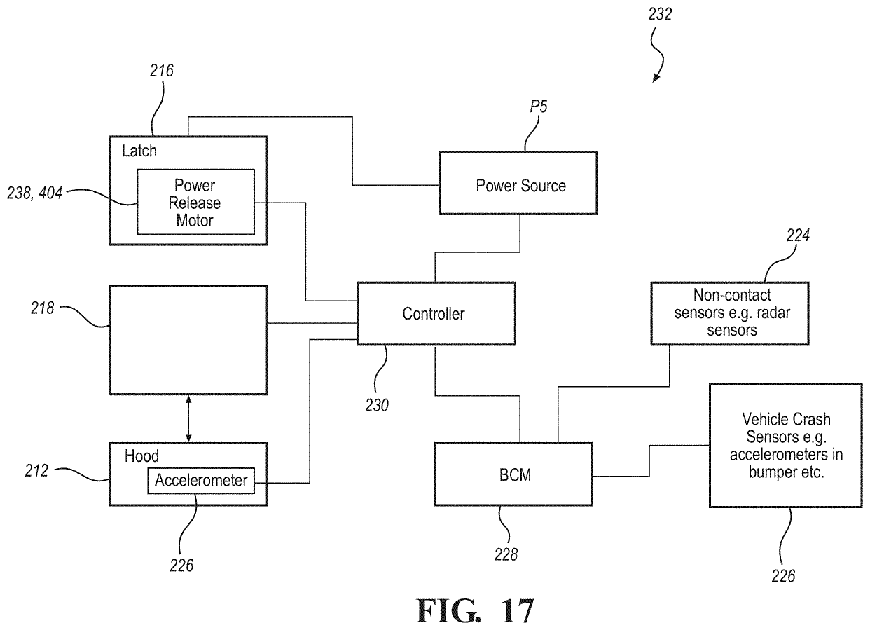

The present disclosure is directed to providing pedestrian protection functionality to the hood 212 via the active hinge assembly 218, which in combination with one or more sensors 224, such as non-contact, radar emitting sensor(s) (FIGS. 11A-11C and 17), such as provided in a front end region of motor vehicle 211, by way of example and without limitation, and/or one or more other sensors 226, such as vehicle crash sensors, including accelerometers, radar emitting sensors, located in desired regions of the motor vehicle 210, by way of example and without limitation, as well as with a body control module (BCM), also referred to as vehicle controller 228, and/or a latch controller 230 (FIG. 17), forms a front hood system 232 in accordance with an aspect of the disclosure.

Front hood system 232 provides a power release function (automatically actuatable via a sensor/controller system) to automatically move hood 212 to the pop-up position in imminent anticipation of a pedestrian P coming into forcible contact with hood 212. Accordingly, if a pedestrian P impacts the hood 212 after actuation of active hinge assembly 218 (FIG. 11C), a cushioned effect of the slightly raised hood 212 is provided, which lessens the impact force to the pedestrian, and can ultimately reduce the potential of the pedestrian P impacting the engine (if present beneath hood 212), thereby reducing the potential for injury to the pedestrian P.

Now turning to FIGS. 11A-11C, a sequence events is illustrated showing detection of pedestrian P in a pedestrian protection zone Z and actuation of a power actuator 234 of front hood system 232 in response to the detection of pedestrian P in the pedestrian protection zone Z to lessen the impact force experienced by the pedestrian P upon impacting the hood 212 of the motor vehicle 211.

In FIG. 11A, a pedestrian P is illustrated in the predetermined pedestrian protection zone Z of motor vehicle 211. The range of distance or pattern of pedestrian protection zone Z can be selected as desired, such as between about 0.1 to 2 meters from a front end of motor vehicle 211, by way of example and without limitation. Within or outside of pedestrian protection zone Z, an advanced driver assistance system (ADAS) can be activated to automatically steer and/or brake vehicle 211 as needed to avoid or lessen impact with another vehicle and/or pedestrian P. The ADAS system can be in operable communication with the one or more sensors 224, by way of example and without limitation, and/or the one or more other sensors 226, as well as with vehicle controller 228, and/or hinge controller 230 (FIG. 17).

Upon pedestrian P having entered pedestrian protection zone Z, sensor 224 detects an imminent side or frontal crash/impact with pedestrian P, thus, sensor 224 communicates with vehicle controller 228 and/or directly with hinge controller 230 to actuate power actuator 234 of active hinge assembly 218 to automatically move a drive member, such as a translatable piston 236, by way of example and without limitation, of power actuator 234 from a retracted, non-actuated position to an extended, actuated position, thereby causing hood 212 to move to its pop-up position.

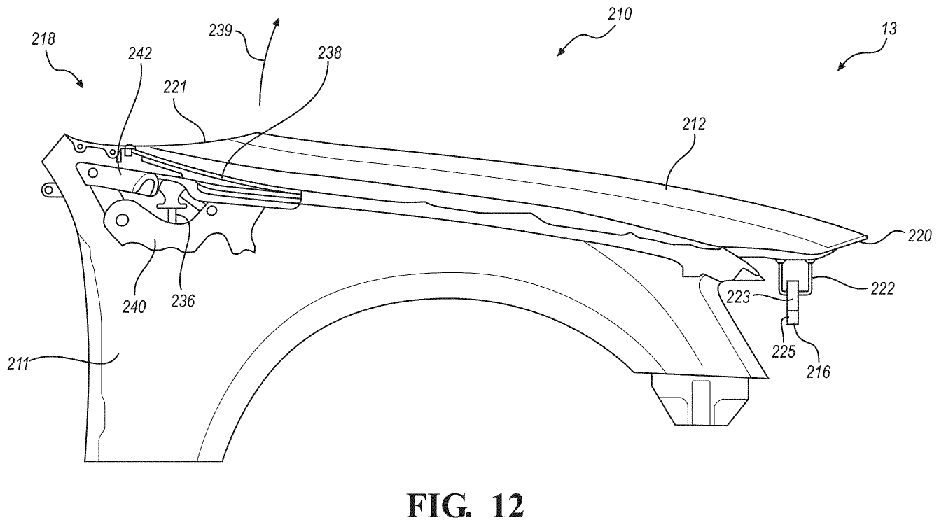

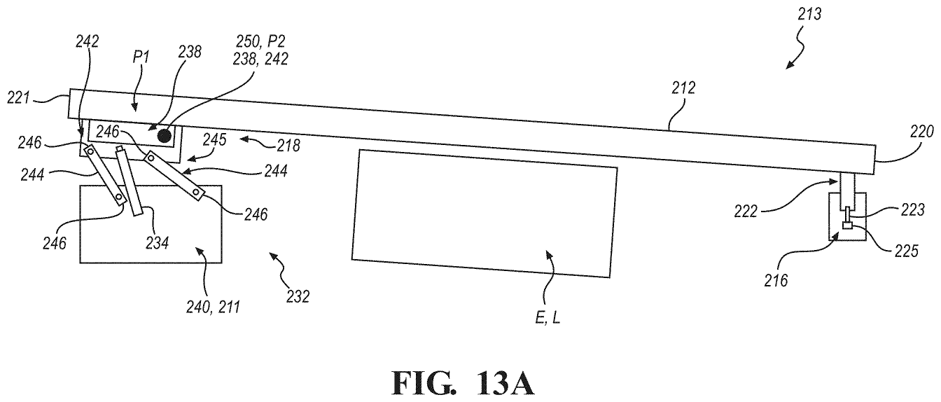

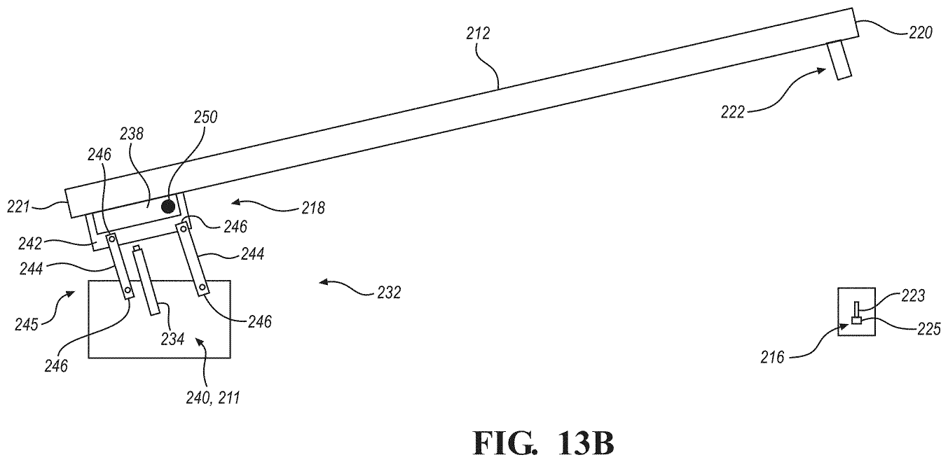

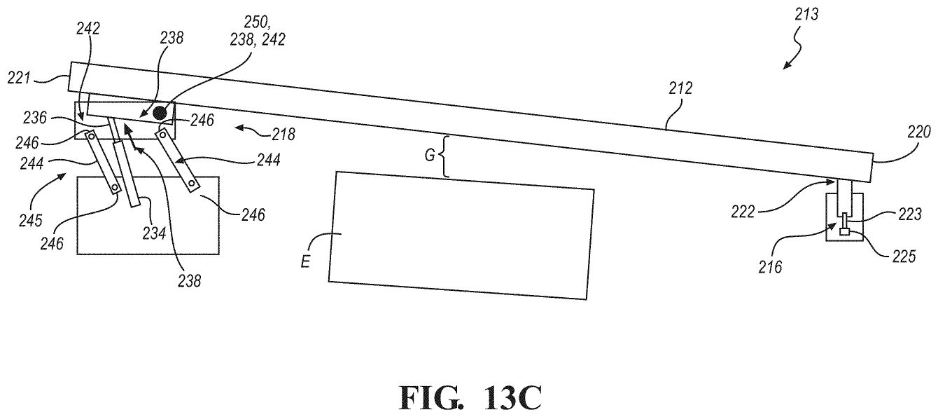

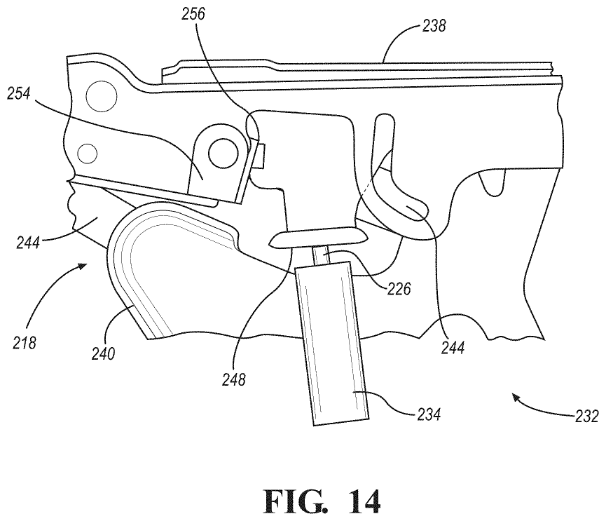

In more detail, upon sensing an imminent impact with a pedestrian P, such as when the pedestrian P enters a pedestrian protection zone Z (FIG. 11A), the piston 236 of the actuator 234 is automatically moved, via actuation from a signal from vehicle controller 228 and/or directly with hinge controller 230, to an actuated position (FIG. 13C, 15, 16D) to move, shown as pivot, a hood bracket 238 of active hinge assembly 218 from a non-deployed position to a raised deployed position causing the second end 221 of hood 212 to move, such as via being pivoted upwardly, as indicated by arrow 239 (FIG. 12), relative to closure latch assembly 216, causing hood 212 to move from a fully closed, rest position to the pop-up position.

Active hinge assembly 218 includes a body bracket 240, a deploy bracket 242, and the hood bracket 238. Body bracket 240 is fixed to vehicle body 211, such as to a fixed frame member thereof. Deploy bracket 242 is operably coupled to body bracket 240 for relative movement therewith, shown as being pivotably coupled to body bracket 240 via a plurality of elongate link members, referred to hereafter as links 244. Links 244 are shown arranged in a four-bar link arrangement, referred to as linkage assembly 245, by way of example and without limitation, have opposite ends 46 (FIGS. 13A-13C) coupled, such as with any variety of pin, dowel or the like, for pivotal movement with body bracket 240 and deploy bracket 242. The linkage assembly 245 is pivotally connected to the deploy bracket 242 generally at a first pivot location P1 adjacent the second end 221 of the hood 212.

During normal use of active hinge assembly 218, when hood 212 is being moved between the fully closed position (FIG. 13A) and the fully open position (FIG. 13 B), linkage assembly 245 allows body bracket 240 to remain fixed relative to vehicle body 211, while allowing deploy bracket 242 to pivot/oscillate relative to body bracket 240, thereby allowing first end 220 of hood 212 to be lifted away from closure latch assembly 216, upon being selectively moving ratchet 223 to its striker release position, to bring hood 212 to its fully open position (FIG. 13B). While pivoting hood 212 to its fully open position, hood bracket 238 can remain fixed relative to deploy bracket 242, thereby moving conjointly with deploy bracket 242 as deploy bracket 242 pivots/oscillates relative to body bracket 240.

During a detected imminent emergency, such as via one or more sensors 224, 226, as discussed above, such as when a pedestrian P has been detected as being within pedestrian detection zone Z and about to impact hood 212, emergency deployment of active hinge assembly 218 is performed. The power actuator 234 is actuated, causing piston 236 to extend upwardly into forcible engagement with hood bracket 238. Hood bracket 238 is shown as having a foot, also referred to as stop feature, also referred to as lock lug or end stop 248, with end stop 248 having a driven surface configured for engagement with an end of piston 236. As piston 236 is extended to its fully actuated position, hood bracket 238 is driven conjointly, being formed as a monolithic piece of material with end stop 248, by way of example and without limitation, to its raised, deployed position. Accordingly, hood 212 is moved to its pop-up position.

As hood bracket 238 moves toward its deployed position, closure latch assembly 216 remains latched, such that hood 212 pivots relative to striker 222, which is retained by ratchet 223 while in its striker capture position. As shown in FIG. 13C, as hood bracket 238 is moving toward its deployed position, links 244 of link assembly 245 can pivot upwardly relative to body bracket 240, while hood bracket 238 pivots upwardly relative to deploy bracket 242 about a pivot axis to its deployed position. The pivot connection between hood bracket 238 and deploy bracket 242 can be provided by a pivot pin 250 connection to deploy bracket 242 (FIGS. 13A-13C) at a second pivot location P2, wherein the second pivot location P2 is shown as being between the first pivot location P1 and the first end 220 of the hood 238. With hood bracket 238 moved to its deployed positon, hood 212 is moved to its pop-up position, thereby providing a cushion to pedestrian P to minimize contact with an engine E, luggage L or whatever else may be beneath hood 212. In order to maintain a cushion provided by a gap G (FIG. 13C) between hood 216 and the engine E, luggage L or otherwise, it is important that the hood 212 remain in its pop-up position upon deployment of hood bracket 238 to its deployed position and while pedestrian P is impact the hood H. Otherwise, if the hood 212 is allowed to move freely from the pop-up position toward its fully closed position, the protection provided to pedestrian P will be reduced.

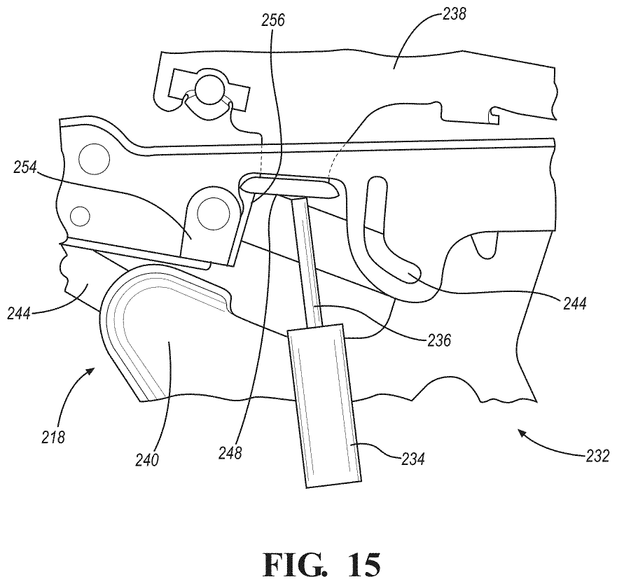

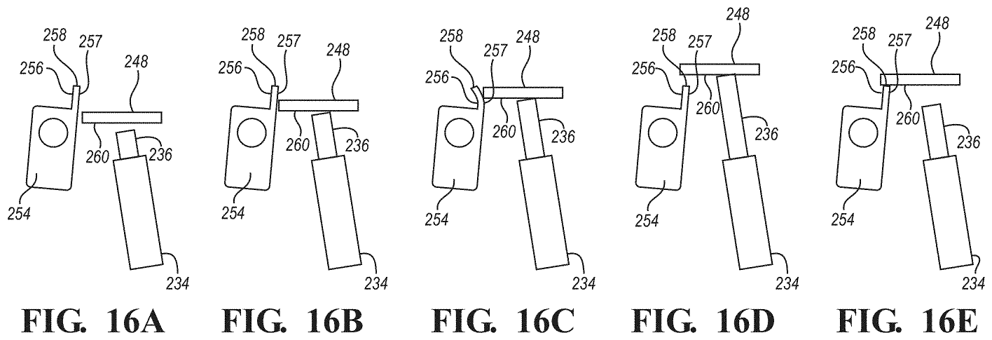

To facilitate maintaining the hood 212 in the pop-up position, regardless of the position of the piston 236 upon being moved to the fully extended, actuated position, a pawl illustratively shown as a spring lock member 252, such as a leaf spring, is provided for locking engagement with end stop 240 (FIGS. 15 and 16E) upon end stop 240 being moved to the deployed position, whereat hood 212 is in the fully raised, pop-up position. Spring lock member 252 has a main body 254 fixed to deploy bracket 242 and a spring finger 256 extending in cantilevered fashion upwardly from main body 254 along a deflection surface 257 to a free end, also referred to as stop surface 258.

In FIGS. 16A-16E, a sequence of actuation of power actuator 234 and deployment of hood bracket 238 is shown. It is to be understood that the entirety of the actuation and deployment occurs within a fraction of a second, as discussed above. During an initial stage of actuation of power actuator 234, piston 236 is extended upwardly into engagement with end stop 248 (FIG. 16B), whereupon end stop 248 is urged upwardly into forcible engagement with deflection surface 257 of spring finger 256. As end stop 248 traverses along deflection surface 257, spring finger 256 is deflected resiliently under the bias force imparted by end stop 248 thereon (FIG. 16C). Then, upon end stop 248 moving upwardly out from engagement with engagement surface (FIG. 16D), spring finger 256 snaps resiliently back to a non-deflected state, whereat stop surface 258 at the free end of the spring finger 256 is aligned axially beneath a lock surface 260 of end stop 248 for engagement with the lock surface 260 when the hood bracket 238 moves from the deployed position toward the non-deployed position. As a result, with hood bracket 238 moved to its deployed position, hood 212 is moved to its pop-up position, and is prevented from moving downwardly from its pop-up position due to stop surface 258 of spring finger 256 confronting lock surface of end stop 248 (FIG. 16E). Accordingly, hood bracket 238 is prevented from moving from its deployed position toward its non-deployed positon, and thus, gap G between hood 212 and engine E, luggage L, or otherwise is maintained, thereby providing optimal cushion and pedestrian protection to pedestrian P upon impacting hood 212.

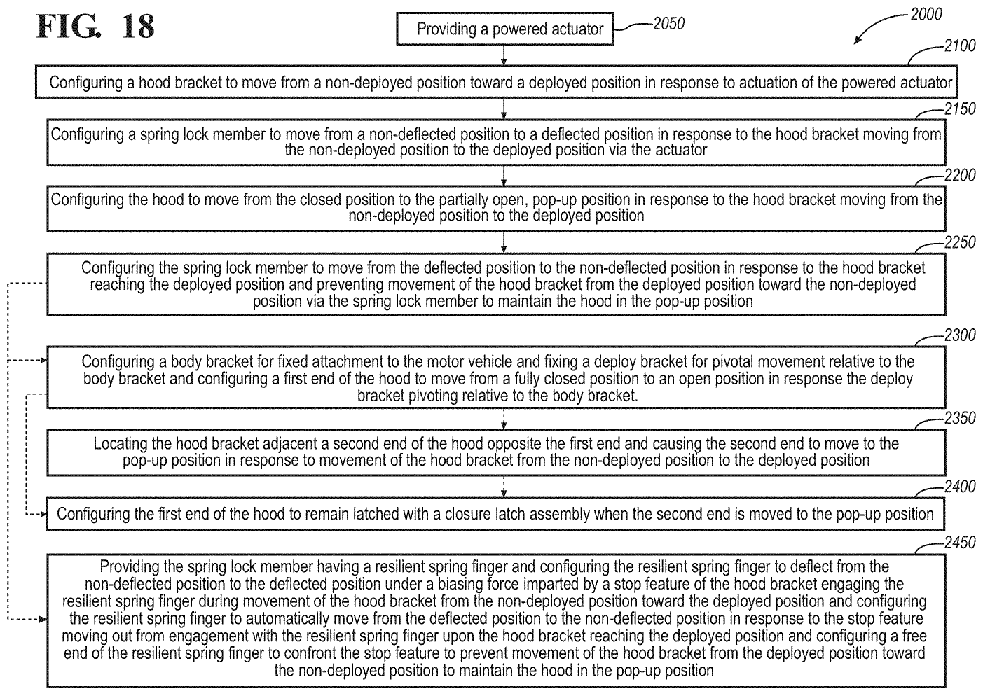

In accordance with another aspect of the disclosure, FIG. 18 illustrates steps of a method 2000 of causing a hood 212 of a motor vehicle 210 to move from a closed position to a partially open, pop-up position, and for maintaining the hood 212 in the partially open, pop-up position, in advance of impacting a pedestrian P to minimize the potential for injury to the pedestrian P upon impacting the hood 212. The method 2000 includes a step 2050 of providing a powered actuator 234; a step 2100 of configuring a hood bracket 238 to move from a non-deployed position toward a deployed position in response to actuation of the powered actuator 234; a step 2150 of configuring a spring lock member 252 to move from a non-deflected position to a deflected position in response to the hood bracket 238 moving from the non-deployed position toward the deployed position with the actuator 234; a step 2200 of configuring the hood 212 to move from the closed position to the partially open, pop-up position in response to the hood bracket 238 moving from the non-deployed position to the deployed position; and a step 2250 of configuring the spring lock member 252 to move from the deflected position to the non-deflected position in response to the hood bracket 238 reaching the deployed position and preventing movement of the hood bracket 238 from the deployed positon toward the non-deployed position with the spring lock member 252 to maintain the hood 212 in the pop-up position.

In accordance with another aspect, the method can further include a step 2300 of configuring a body bracket 40 for fixed attachment to the motor vehicle 210 and fixing a deploy bracket 242 for pivotal movement relative to the body bracket 240 and configuring a first end 220 of the hood 212 to move from a fully closed position to an open position in response the deploy bracket 242 pivoting relative to the body bracket 240.

In accordance with another aspect, the method can further include a step 2350 of locating the hood bracket 238 adjacent a second end 221 of the hood 212 opposite the first end 220 and causing the second end 221 to move to the pop-up position in response to movement of the hood bracket 238 from the non-deployed position to the deployed position.

In accordance with another aspect, the method can further include a step 2400 of configuring the first end 220 of the hood 212 to remain latched with a closure latch assembly 216 when the second end 221 is moved to the pop-up position.

In accordance with another aspect, the method can further include a step 2450 of providing the spring lock member 252 having a resilient spring finger 256 and configuring the resilient spring finger 256 to deflect from the non-deflected position to the deflected position under a biasing force imparted by a stop feature 248 of the hood bracket 238 engaging the resilient spring finger 256 during movement of the hood bracket 238 from the non-deployed position toward the deployed position and configuring the resilient spring finger 256 to move from the deflected position to the non-deflected position in response to the stop feature 258 moving out from engagement with the resilient spring finger 256 upon the hood bracket 238 reaching the deployed position and configuring a free end 258 of the resilient spring finger 256 to confront the stop feature 248 to prevent movement of the hood bracket 238 from the deployed positon toward the non-deployed position to maintain the hood 212 in the pop-up position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure panel for a motor vehicle for movement from a fully closed position, whereat the closure panel closes off an opening into an interior cabin of the motor vehicle, to an open position, whereat the closure panel allows ingress through the opening into the interior cabin and egress through the opening from the interior cabin, comprising:
a latch assembly having a latch mechanism with a ratchet moveable between a striker release position, whereat the ratchet is positioned to release a striker to permit the closure panel to move to the open position, and a primary striker capture position, whereat the closure panel is held in the fully closed position, a pawl moveable between a ratchet holding position, whereat the pawl is positioned to hold the ratchet in its primary striker capture position, and a ratchet releasing position, whereat the pawl is positioned to permit movement of the ratchet to its striker release position;
a latch release mechanism configured for powered actuation of the latch mechanism to move the pawl between the ratchet holding position and the ratchet releasing position and having a manually actuatable release lever moveable between a non-actuated position, whereat the manually actuatable release lever permits the pawl to be located in its ratchet holding position, and an actuated position, whereat the manually actuatable release lever causes the pawl to move to its ratchet releasing position;
a cover configured for movement between a covered position, whereat access to the manually actuatable release lever is prevented, and an uncovered position, whereat access to the manually actuatable release lever is permitted,
wherein while the cover is in the covered position, manual actuation of the manually actuatable release lever by a user is prevented, and while the cover is in the uncovered position, manual actuation of the manually actuatable release lever by the user is permitted.

2. The closure panel of claim 1, wherein the cover has a blocking feature configured to prevent movement of the manually actuatable release lever from the non-actuated position to the actuated position.

3. The closure panel of claim 2, wherein the blocking feature engages the manually actuatable release lever when the cover is in the covered position.

4. The closure panel of claim 1, wherein the cover is configured for attachment directly to a metal panel underlying a decorative inner panel of the closure panel, wherein the decorative inner panel is configured to allow access to the cover when desired.

5. The closure panel of claim 1, wherein the cover is configured for attachment directly to a decorative inner panel of the closure panel.

6. The closure panel of claim 4, wherein the cover is accessible to be moved from the covered position to the uncovered position from the interior cabin of the motor vehicle while the closure panel is in the fully closed position.

7. The closure panel of claim 1, wherein the manually actuatable release lever is only moveable from the non-actuated position to the actuated position when the cover is in the uncovered position.

8. The closure panel of claim 1, wherein the closure panel has at least one of an outside closure panel handle and an inside closure panel handle, the at least one outside closure panel handle and inside closure panel handle being configured in electrical communication with the latch release mechanism.

9. The closure panel of claim 8, wherein the at least one outside closure panel handle and inside closure panel handle are not in mechanically coupled communication with the latch release mechanism.

10. The closure panel of claim 1, wherein the latch mechanism includes a powered-operated cinch mechanism moveable between a rest position, whereat the powered-operated cinch mechanism is disengaged from the ratchet, and an engaged position, whereat the powered-operated cinch mechanism engages the ratchet to move the ratchet from a secondary striker capture position to its primary striker capture position, wherein the manually actuatable release lever is moveable from the non-actuated position to the actuated position to over-ride the powered-operated cinch mechanism.

11. A door for a motor vehicle, comprising:
a latch assembly having a manually actuatable release lever; and
a cover concealing the manually actuatable release lever from a user within an interior cabin of the motor vehicle while in a covered position,
wherein the manually actuatable release lever is made accessible for selective activation by the user within the interior cabin after the cover has been moved from the covered position to an uncovered position.

12. The door of claim 11, wherein the cover has a blocking feature configured to prevent movement of the manually actuatable release lever from the non-actuated position to the actuated position while in the covered position.

13. The door of claim 12, wherein the manually actuatable release lever is only moveable from the non-actuated position to the actuated position when blocking feature is moved out from engagement with the manually actuatable release lever upon the cover being moved to the uncovered position.

14. The door of claim 11, wherein the door can only be moved from the closed position to an open position via powered actuation of an electric motor while the cover is concealing the manually actuatable release lever.

15. The door of claim 14, wherein the closure panel has at least one of an outside closure panel handle and an inside closure panel handle, the at least one outside closure panel handle and inside closure panel handle being configured in electrical communication with a latch release mechanism.

16. The door of claim 15, wherein the at least one outside closure panel handle and inside closure panel handle are not in mechanically coupled communication with the latch release mechanism.

17. A method of permitting a power-actuated latch mechanism of a closure panel of a motor vehicle to be mechanically unlatched to allow the closure panel to be moved from a closed position to an open position, comprising:
providing the closure panel having a cover that is moveable from a covered position to an uncovered position to gain access to a manually actuatable release lever of the power-actuated latch mechanism; and
configuring the manually actuatable release lever for movement from a non-actuated position to an actuated position, whereat the power-actuated latch mechanism moves from a latched state to an unlatched state, whereat the closure panel can be moved from the closed position to the open position.

18. The method of claim 17, further including locating the cover on the closure panel to allow a user in an interior cabin of the motor vehicle to have access to the cover while the closure panel is in the closed position.

19. The method of claim 17, further including configuring the cover to prevent the manually actuatable release lever from moving from the non-actuated position to the actuated position while the cover is in the covered position.

20. The method of claim 17, further including configuring the manually actuatable release lever to over-ride a powered-operated cinch mechanism upon being moved from the non-actuated position to the actuated position.
